(19) United States
(12) Patent Application Publication
(10) Pub. No.: US 2011/0067980 A1
(43) Pub. Date: Mar. 24, 2011

(54) Chain Link and Chain

(76) Inventor: Shanon Matthew Martin, Palmerston North (NZ)

(21) Appl. No.: 12/736,555

(22) PCT Filed: Apr. 17, 2009
(86) PCT No.: PCT/NZ2009/000056

§ 371 Date: Dec. 8, 2010

(30) Foreign Application Priority Data
Apr. 18, 2008 (NZ) 567552

(51) Int. Cl. B65G 17/38

(52) U.S. Cl. 198/851

(57) ABSTRACT

A chain link for a conveyor chain includes connection apertures at each end which cooperate with apertures in an adjacent link for connection of the links in an assembled chain. The apertures may be shaped so as to provide rotation between adjacent links in two planes, with the chain also performing well under either tension or compression. Chain links may be formed from two pieces which are joined together along a longitudinal join, facilitating assembly and disassembly of the chain link and chain. The link may include a reinforcing insert encased in polymer, providing a strong chain link with the advantages of a polymer surface.

### FIELD OF THE INVENTION

The invention relates to chain links and chains, in particular to chain links and chains for conveyor systems.

### BACKGROUND TO THE INVENTION

Chains are used in conveyors, particularly in overhead conveyors for transporting parts or goods in an industrial setting. A chain generally rides in a fixed track and hooks or other connectors are attached to the chain such that parts or goods can hang from those hooks or connectors.

Existing chains suffer from a number of drawbacks. The chain links are often complex, requiring a large number of parts and significant assembly time, and are therefore costly. Disassembly is also time consuming, and therefore maintenance or changes to conveyor paths are difficult and costly.

Moreover, such complexity generally results in large numbers of joins between parts. In applications in the food industry this creates significant hygiene problems, since particles of food, dirt or other contaminants can lodge in those joints. Contamination is exacerbated by condensation caused by low or varying temperatures within industrial plants and the metal material generally used for such chains.

Furthermore, many chain links require lubrication. This again creates hygiene and potentially contamination problems, particularly in the food industry.

Existing chains often do not operate well both when the links are under tension (i.e. when the links are pulling on each other) and when the links are under compression (i.e. when the links are pushing on each other).

It is an object of the invention to provide improved chain links and/or an improved chain, or at least to provide the public with a useful choice.

### SUMMARY OF THE INVENTION

In a first aspect the invention provides a chain link for a conveyor system chain, including a link body and one or more wheels, the link body including near each end thereof a connection aperture for connection between the chain link and an adjacent link in an assembled chain, wherein:

each connection aperture is configured to provide contact between a first inner surface of the connection aperture and a first inner surface of a cooperating connection aperture on an adjacent link when the links pull against each other; and each connection aperture is configured to provide contact between a second inner surface of the connection aperture and a cooperating end surface of an adjacent link when the links push against each other.

In a second aspect the invention provides a chain link for a conveyor system chain, including a link body and one or more wheels, wherein the link body is substantially formed from two pieces joined along a longitudinal join.

In a third aspect the invention provides a chain link for a conveyor system chain, including a link body and one or more wheels, wherein the link body includes one or more reinforcing inserts at least partially encased in polymer material.

### BRIEF DESCRIPTION OF THE DRAWINGS

The invention will now be described by way of example only, with reference to the accompanying drawings, in which:

FIG. 1 is a perspective view of a chain link according to one embodiment;

FIG. 2 is a side elevation of the chain link of FIG. 1;

FIG. 3 is an end elevation of the chain link of FIG. 1;

FIG. 4 is an exploded view of the chain link of FIG. 1;

FIG. 5 shows a short section of chain, including chain links as shown in FIG. 1;

FIG. 6 shows a short section of chain riding in a conveyor track;

FIG. 6A is a cross-section through a suitable conveyor track;

FIG. 7 is a top plan view of the chain link of FIG. 1;

FIG. 8 is a perspective view of a metal insert, for a chain link according to a further embodiment; and

FIG. 9 shows two connected metal inserts for a chain link according to this further embodiment.

### DETAILED DESCRIPTION

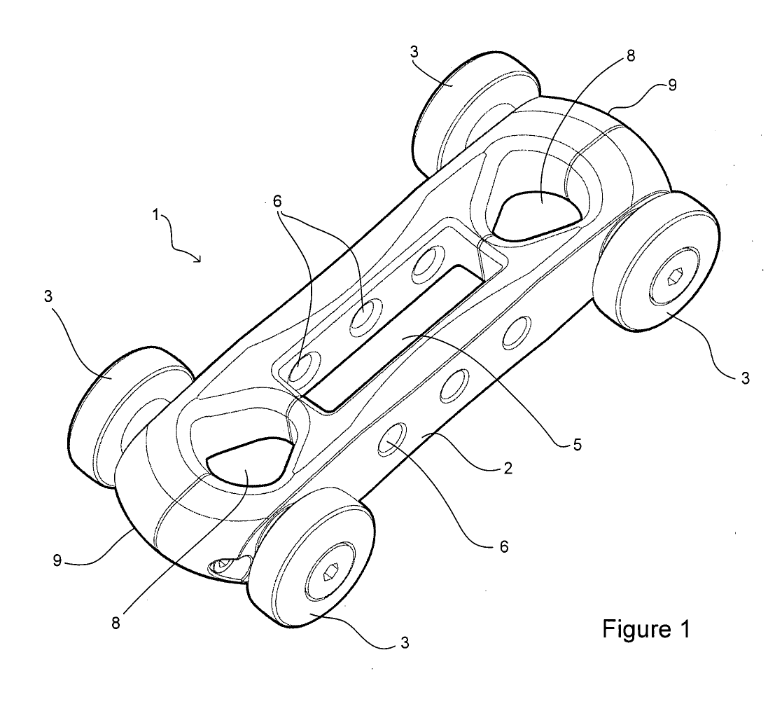

FIG. 1 is a perspective view of a chain link 1 according to one embodiment. The chain link is configured for assembly with a number of other links in order to form a chain for a conveyor system, such as an overhead conveyor system.

The chain link 1 includes a link body 2 and a number of wheels 3. The link body 2 includes a central aperture 5 and a number of lateral apertures 6. Any of these apertures may be used for connection of a hook, gambrel or other connector, such that a load can hang below the chain link.

The link body 2 also includes a connection aperture 8 near each end of the link body 2. These connection apertures 8 are used for connection of adjacent links in an assembled chain. The link body 2 also includes end contact surfaces 9. The connection apertures 8 and contact surfaces 9 will be discussed in detail below.

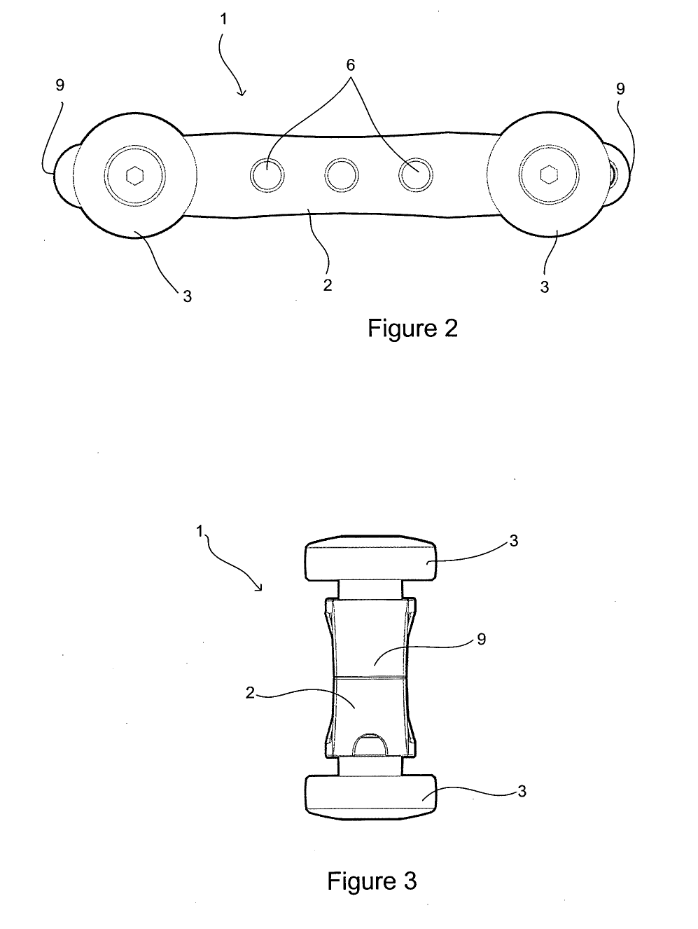

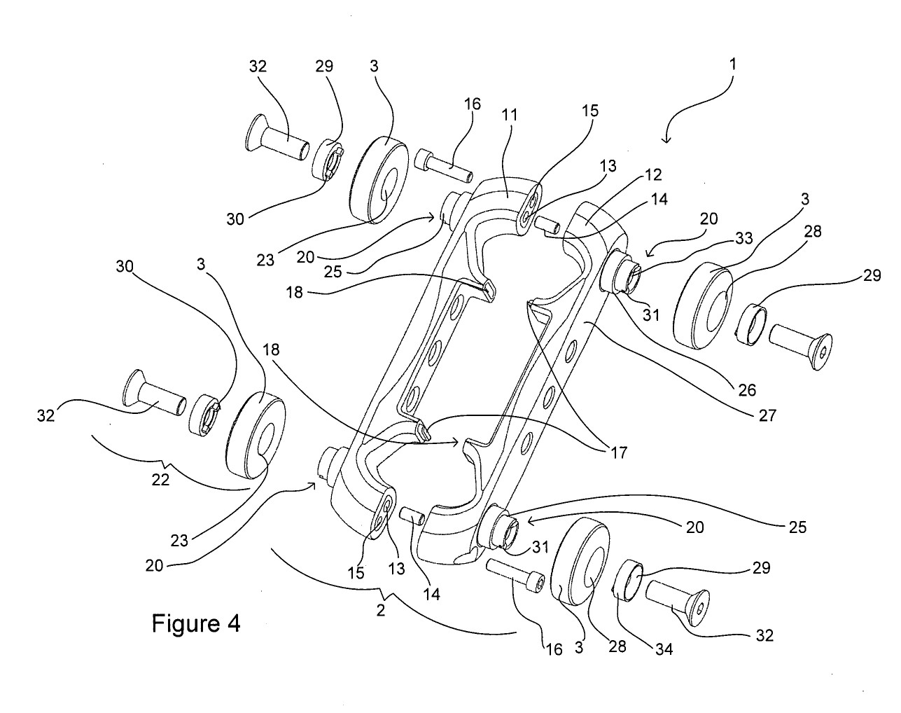

FIGS. 2 and 3 are a side view and an end view respectively of the chain link 1.

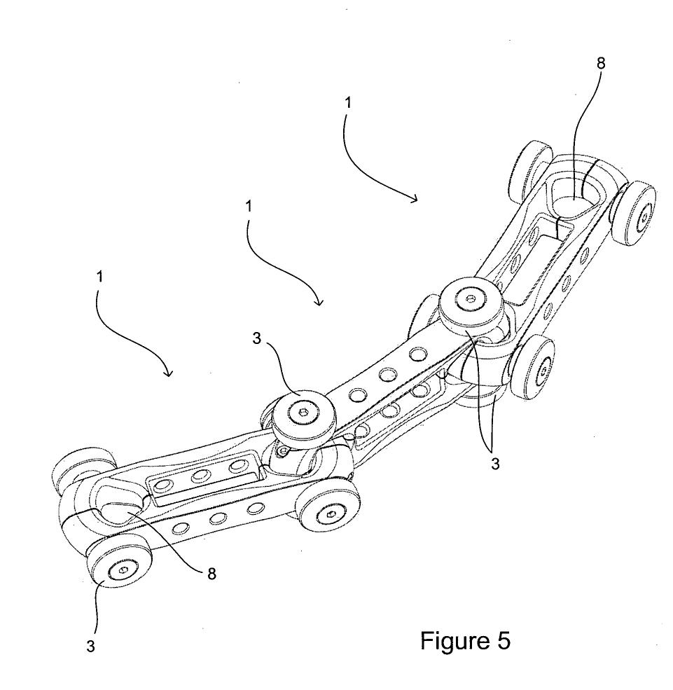

FIG. 4 is an exploded view of the chain link 1. This view shows that the link body 2 is formed in two parts 11, 12 which are joined along a longitudinal join. Preferably, the two parts 11, 12 are identical. Each part 11, 12 of the link body 2 may include a number of apertures for connection of the two parts 11, 12. In the embodiment shown, each part 11, 12 includes at each end a first aperture 13 which receives an alignment rod 14 and a second aperture 15 which receives a fastener 16 for connection of the two parts 11, 12. Each alignment rod may be pressed into one side of the link. Further cooperating elements, such as elements 17, 18 may be provided along the length of the two parts 11, 12.

The link body 2 also includes four wheel mounting arrangements 20. In the assembled chain link 1 a wheel assembly 22 mounts to each wheel mounting arrangement 20. Each wheel assembly 22 includes a wheel 3 which has an inner bore 23 which cooperates with a cylindrical section 25 of the wheel mounting arrangement 20. A shoulder 26 of each wheel mounting arrangement 20 has an outer diameter larger than the bore 23 of the wheel 3 and therefore holds the wheel 3 slightly away from the side 27 of the link body 2.

A counterbore 28 of larger diameter then the bore 23 is formed in the outer part of each wheel 3. This counterbore 28 receives a retaining washer 29, each washer 29 having a pair of protrusions 30 which engage with slots 31 in the cylindrical section 25 of the wheel mounting arrangement 20.

This keying arrangement prevents rotation of the retaining washer 29 with respect to the wheel mounting arrangement, which reduces the risk of the wheel assembly being loosened simply by rotation of the wheel. It also allows the wheels to be fastened to predetermined tolerances, since the position of the wheel is set by the cooperation of the retaining washer 28 and wheel mounting arrangement 20, rather than by the tightening of the fastener (described below) which secures the wheel assembly 22 to the link body 2. Clearly many different keying arrangements may be suitable. The arrangement chosen should provide an appropriate compromise between rotational strength and ease of assembly.

Each wheel assembly 22 includes a fastener 32 which engages with the retaining washer 29 and a central hole 33 in each wheel mounting arrangement 20. Thus, when fixed to the link body 2, each wheel 3 rides on the cylindrical section 25 of the wheel mounting arrangement 20 and the cylindrical surface 34 of the retaining washer 29. Alternatively, each wheel could ride on one of the surfaces 24, 34.

In some embodiments, metallic roller or ball type bearings may be used.

The link body is therefore formed substantially in two pieces, although a number of connecting elements may also be required, such as the fasteners and alignment rods in the embodiment shown. This two-part structure reduces the number of joins required and therefore reduces the problems associated with contamination of joins by food, dirt or other contaminants. This is particularly important in the food processing industry.

The two parts 11, 12 are preferably identical. The parts are joined along a longitudinal join which passes through the connection apertures, which allows simple assembly of the chain. Each chain link 1 can be assembled such that one of its connection apertures 8 engages with an adjacent, previously assembled link. Similarly, disassembly of a chain or a chain link is facilitated by this structure.

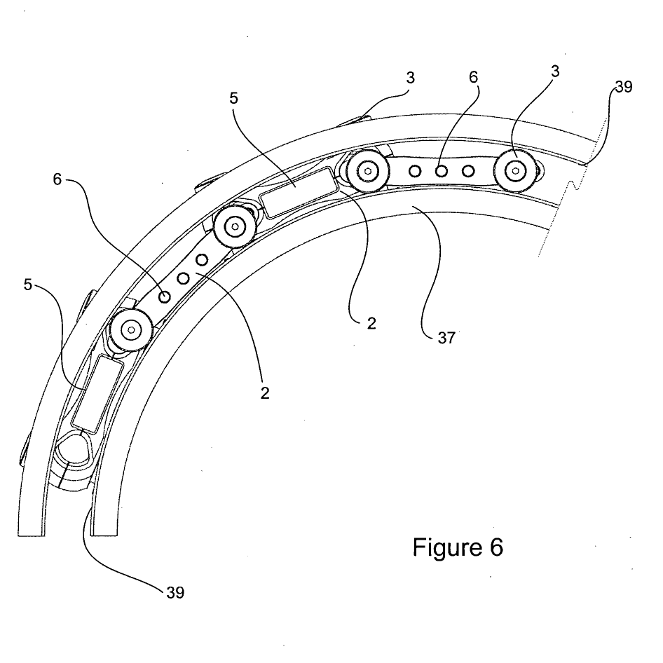

FIG. 5 shows a short section of assembled chain, consisting of three identical chain links 1, with adjacent links oriented perpendicular to each other. This drawing clearly shows the adjacent links connected using the connection apertures 8 in each link 1.

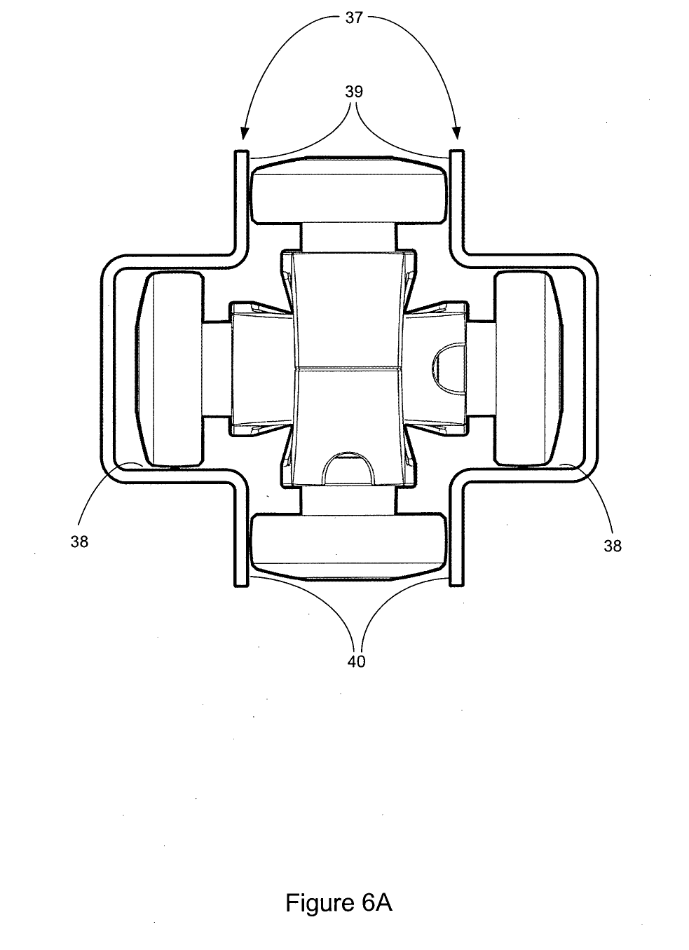

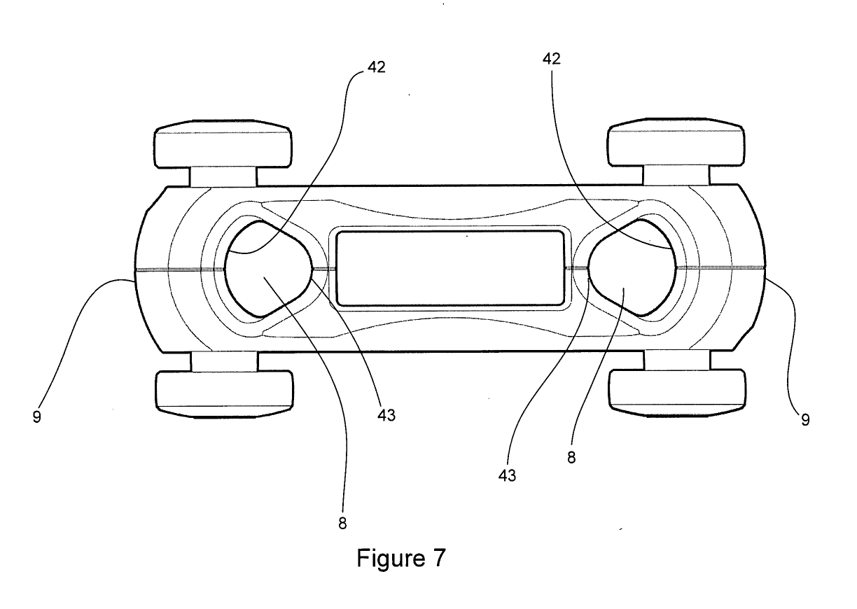

FIG. 6 shows another short section of assembled chain, riding in a track of the type shown in cross-section in FIG. 6A. The track 37 has a generally cross-shaped cross-section. Every second link is oriented horizontally, and the wheels of those links ride on surfaces 38 to transfer the weight of the chain and any load onto the track 37. These wheels also steer the chain around any bends in the track in the vertical plane (i.e. bends up or down).

Alternate links are oriented vertically and the wheels of those links ride on surfaces 39, 40 in order to steer the chain around bends in the track, these bends being in the horizontal plane.

The connection apertures 8 are designed so as to allow free rotation of adjacent links around the connection between those links, in both the vertical and horizontal planes, both when the chain is under tension and under compression.

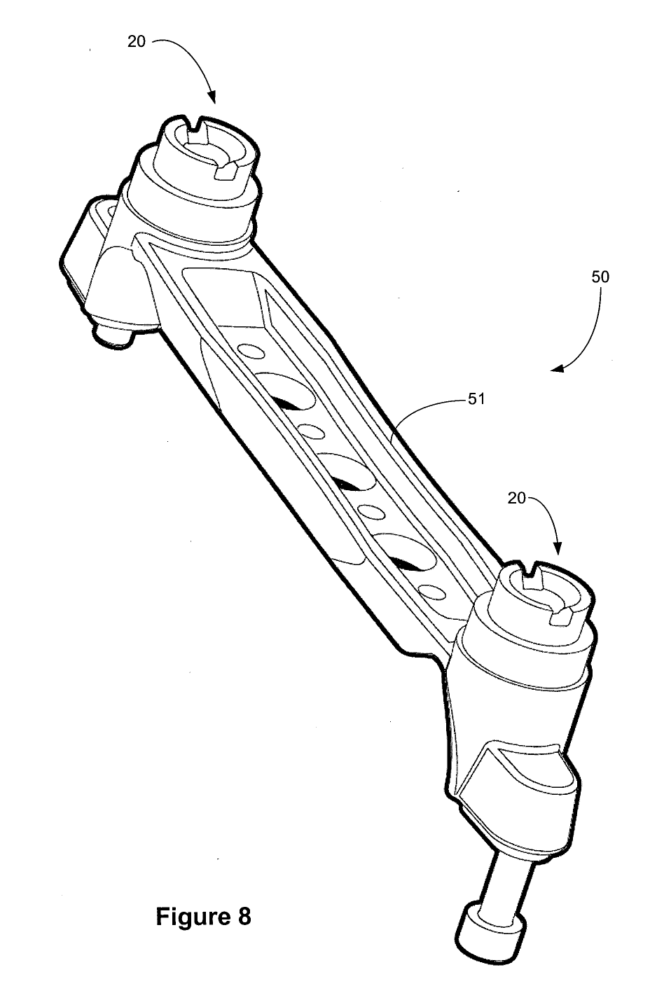

With reference to FIG. 7, which is a plan view of a chain link 1, each connection aperture 8 includes a first inner contact surface 42 which is concave in the plane of the paper (i.e. in or parallel to a plane in which the wheel's axes of rotation lie). In the plane perpendicular to the paper, each first contact surface 42 is convex.

When adjacent links are joined as shown in FIG. 5 and are under tension, the concave curvature of the first contact surface 42 of one link cooperates with the convex curvature of the same surface 42 of the adjacent link, since the links are oriented perpendicular to each other. This provides for free rotation at the connection between the two links, in both the horizontal and vertical planes, when the chain is under tension.

Each connection aperture 8 also includes a second contact surface 43 which is concave in the plane of the paper. When the chain is under compression, the end contact surface 9 of one link 1 pushes against the inner contact surface 43 of an adjacent link. The end contact surface 9 is convex in both the plane of the paper and in the plane perpendicular to the paper. As the links are preferably identical, this provides four contact faces at each join between links, when under compression.

Each join includes two cooperating connection apertures, with the two inner contact surfaces of the links contacting the two end contact surfaces 9 of the links. This increases strength and wear resistance.

Each connection aperture also has a shape which is narrower towards its second contact surface 43 than at its first contact surface 42.

These features mean that there is also free rotation at the connection between two links, in both the horizontal and vertical planes, when the chain is under compression.

The shaped contact surfaces described above also facilitate a small minimum bend radius, allowing tight bends to be formed in the track. In addition, maximising the contact area between links as described above reduces wear. The two parts 11, 12 of the link could also be formed from a material with high lubricity, eliminating the need for potentially contaminating lubricants. This is facilitated by the large contact areas.

Free rotation between adjacent links provides several advantages. The chain can be used with complex track geometries, including vertical, horizontal and compound (i.e. both horizontal and vertical) bends. The chain does not resist motion around bends as some existing chains do, leading to lower wear and lesser maintenance requirements.

Furthermore, the Applicant achieves these results using a simple link geometry with few parts. Fewer components are required for servicing. In contrast, previous attempts to improve rotation between links have required expensive and complex joints, such as universal joints.

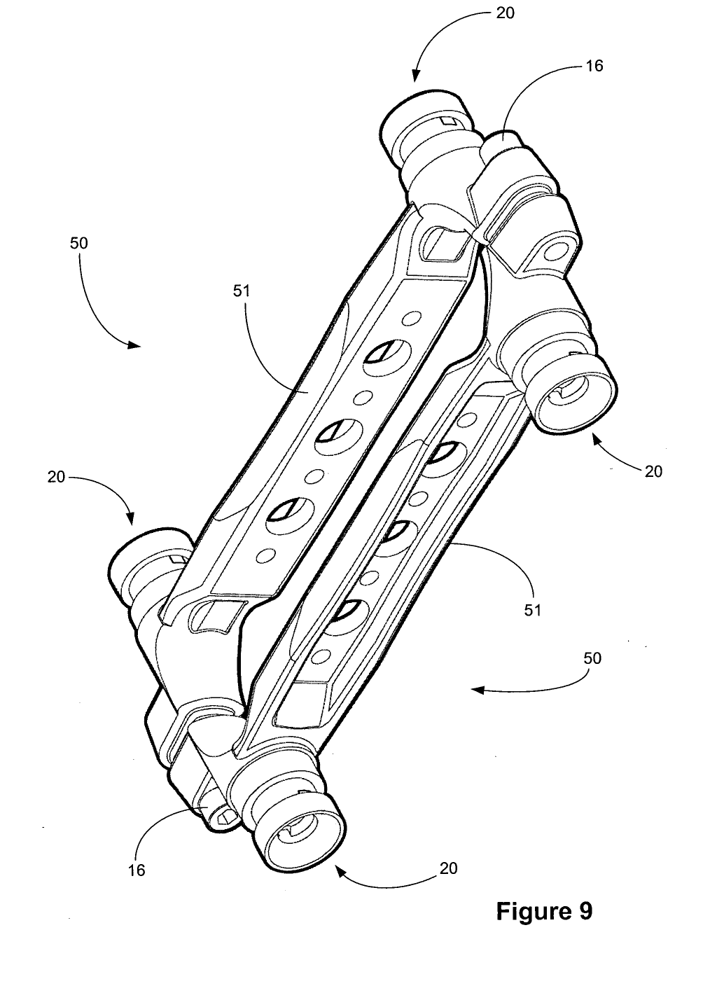

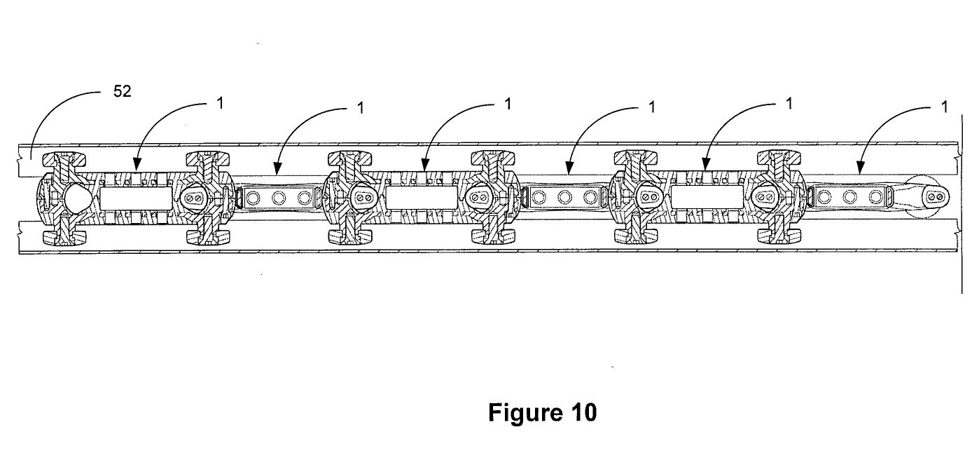

FIGS. 8 and 9 show a further embodiment in which a reinforcing insert is used to strengthen each link body 2. This may increase both load carrying capacity and longitudinal (i.e. drive) strength.

FIG. 8 is a perspective view of a reinforcing insert 50. The insert 50 may be formed from metal or other strong material, such as engineering plastics, composite materials (including carbon based materials), resins, ceramics etc. Preferably the volume of the insert 50 is the minimum required for the particular application, so as to minimise cost.

The insert 50 includes two wheel mounting arrangements 20 and an insert bar 51 extending between the wheel mounting arrangements 20.

FIG. 9 shows two identical reinforcing inserts 50 joined by fasteners 16. The assembled inserts 50 thus form a reinforced framework to which the wheels 3 will be attached. The assembled inserts form a closed loop for transmission of tension forces. Furthermore, the insert bars 51 will support any load applied to the chain link.

Each reinforcing insert is at least partially encased with a suitable material (such as a polymer material) so as to form a link body part 11, 12 similar in appearance to those shown in FIG. 4. The wheel mounting arrangements 20 and the holes for receiving the fasteners 16 will of course protrude from or be accessible through holes in the encasing material.

The reinforcing insert may for some applications protrude in contact areas (such as contact surfaces 9, 42 and 43) so as to increase durability. However, this must be balanced against the disadvantages of exposed insert surfaces (e.g. longevity, lubricity, noise, condensation, oxidation, hygiene, contamination) and therefore may not be suitable for some applications.

Embodiments of the Applicant's chain link which include such inserts may be suitable for applications where larger links are required or where larger loads are applied to the links.

The link body 2 (or the covering of the link body if inserts are used) may be formed from a polymer material. Preferably a material with high lubricity is used. The material may be an engineering polymer such as nylon or acetal. Unlike metal chain links, the polymer does not conduct heat well and therefore reduces condensation on the chain and its associated contamination risks. This is particularly important in applications where cold or varying temperatures are to be expected, including in the food processing industry. Where metallic inserts are used, preferably the insert has the lowest volume and surface area possible for the application, so as to reduce the risk of condensation.

The wheels 3 are preferably formed from a plastic material for reduced noise and wear. The material is preferably self-lubricating so as to eliminate the need for potentially contaminating lubricants to be applied. Preferably a material with high lubricity is used. The material may be an engineering polymer such as nylon or acetal.

The Applicant's chain may be driven in any suitable manner. For example, a gear or cog could be arranged on some or all of the cylindrical axle surfaces of the wheel assemblies 20. The shoulder 26 creates sufficient room for this gear or cog. These gears or cogs could be provided on every link or only on some links. The gears or cogs engage with a drive gear or cog, as will be understood by a skilled reader. The drive load may be applied to links oriented vertically.

The Applicant's chain is particularly suited to the food processing industry. The simple construction provides very few traps for collection of food particles, dirt, condensation and other contaminants. Self lubricating wheels mean that potentially contaminating lubricants are not required.

The polymer materials reduce condensation, which is advantageous for the food processing industry and also for other applications where cold or variable temperatures are experienced. Polymer materials also reduce workplace noise.

The geometry of the link is scalable and may therefore be used for chain links of any desired dimension. For those applications requiring links with greater strength, reinforcing inserts may be used.

The connection apertures allow rotation of links in two planes. This provides a versatile chain which works well in many settings and track geometries. However, no complex joint (such as a universal joint) is required. This configuration is also strong, since the material between the connection aperture and the end of the link can be made fairly thick, even where a material of relatively low strength is used. Prior links were limited by the strength of the joint (for example by the shear strength of a pin in the universal joint).

The links are easily assembled by connecting the two parts of the link body using a small number of fasteners. The links include a small number of parts, leading to reduced manufacture costs and assembly time.

The links can be disassembled at any point along a chain, including disassembly at a point within the confines of the track. This is advantageous since it facilitates maintenance and changes to the track.

A load applied to the chain is preferably applied to a link oriented horizontally. This load will then be evenly and fully supported by the four wheels of that link.

Each chain link body is preferably formed from two identical halves. This reduces tooling and other manufacturing costs and also reduces the number of spare parts which must be kept on site. The link halves are keyed (e.g. at points 17 and 18) so that it is impossible to assemble the link in an incorrect manner.

Each chain link is also symmetrical, each end of the link being the same (excluding fastener holes etc). This facilitates assembly of the chain, since the link can be connected in any manner to the preceding link.

The links are suitable for use with any standard hooks, gambrels or other connectors for attaching loads to the links.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. A chain link for a conveyor system chain, including a link body and one or more wheels, the link body including near each end thereof a connection aperture for connection between the chain link and an adjacent link in an assembled chain, wherein:
a. each connection aperture is configured to provide contact between a first inner surface of the connection aperture and a first inner surface of a cooperating connection aperture on an adjacent link when the links pull against each other; and
b. each connection aperture is configured to provide contact between a second inner surface of the connection aperture and a cooperating end surface of an adjacent link when the links push against each other.

2. A chain link as claimed in claim 1 wherein each connection aperture is shaped so as to allow the link to rotate relative to an adjacent link in two planes, whether the links are pushing or pulling against each other.

3. A chain link as claimed in claim 1 wherein the first inner surface is concave in a first plane in which the axes of rotation of the wheels lie and convex in a second plane perpendicular to the first plane and the second inner surface is concave in the first plane.

4. (canceled)

5. A chain link as claimed in claim 3 wherein an end surface of the chain link is convex in the first plane and convex in the second plane.

6. A chain link as claimed in claim 1, wherein the link body is substantially formed from two pieces joined along a longitudinal join passing through each connection aperture, such that the connection apertures are formed by connection of the two pieces.

7. A chain link as claimed in claim 6 wherein the two pieces of the link body are identical.

8. (canceled)

9. A chain link as claimed in claim 1, wherein the link body is substantially formed from a polymer material.

10. A chain link as claimed in claim 6 wherein each piece of the link body includes a reinforcing insert at least partially encased in a polymer material.

11. (canceled)

12. (canceled)

13. A conveyor system chain including a plurality of chain links as claimed in claim 1.

14. (canceled)

15. A conveyor system chain as claimed in claim 13 wherein adjacent chain links are oriented perpendicular to each other such that the chain is configured to ride in a cross-shaped track.

16. (canceled)

17. A chain link for a conveyor system chain, including a link body and one or more wheels, wherein the link body is substantially formed from two pieces joined along a longitudinal join.

18. A chain link as claimed in claim 17 wherein the two pieces of the link body are identical.

19. (canceled)

20. (canceled)

21. (canceled)

22. (canceled)

23. A chain link as claimed in claim 17 including near each end thereof a connection aperture for connection between the chain link and an adjacent link in an assembled chain, wherein the longitudinal join passes through each connection aperture, such that the connection apertures are formed by connection of the two pieces.

24. A chain link as claimed in claim 17, wherein the link body is substantially formed from a polymer material.

25. A chain link as claimed in claim 17 wherein each piece of the link body includes a reinforcing insert at least partially encased in a polymer material.

26. (canceled)

27. (canceled)

28. A conveyor system chain including a plurality of chain links as claimed in claim 17.

29. (canceled)

30. A conveyor system chain as claimed in claim 28 wherein adjacent chain links are oriented perpendicular to each other such that the chain is configured to ride in a cross-shaped track.

31. (canceled)

32. A chain link for a conveyor system chain, including a link body and one or more wheels, wherein the link body includes one or more reinforcing inserts at least partially encased in polymer material.

33. (canceled)

34. (canceled)

35. (canceled)

36. (canceled)

37. A chain link as claimed in claim 32 wherein the polymer casing allows the reinforcing insert to protrude at one or more contact regions for increased durability.

38. A chain link as claimed in claim 32 wherein the reinforcing inserts in an assembled chain link form a closed loop.

39. (canceled)

40. (canceled)

41. (canceled)

42. (canceled)
